(19) United States
(12) Patent Application Publication
(10) Pub. No.: US 2009/0119924 A1
(43) Pub. Date: May 14, 2009

(54) VIBRATING WET SHAVER

(76) Inventor: Ioannis Bozikis, Athens (GR)

Correspondence Address: JONES DAY, 222 EAST 41ST ST, NEW YORK, NY, 10017, US

(21) Appl. No.: 11/574,841

(22) PCT Filed: Sep. 6, 2005
(86) PCT No.: PCT/FR05/09621

§ 371 Date: May 21, 2007

(51) Int. Cl. B26B 19/28; B26B 21/00

(52) U.S. Cl. 30/45; 30/50; 30/526; 30/44

(57) ABSTRACT

A vibrating wet shaver that includes a hollow handle, a shaving head borne by the handle, and an electric vibratory that includes a rigid casing that is fixed inside the handle for transmitting vibrations to the shaving head through the handle. The casing of the vibratory is tightly fitted in the handle, and at least an elastomeric layer is interposed between the casing and the handle.

This application is a national stage application of PCT/FR2005/009621, filed on Sep. 6, 2005.

The embodiments of the present invention relate to a vibrating shaver.

### FIELD OF THE INVENTION

### Background of the Invention

More precisely, the embodiments of the present invention relates to a vibrating wet shaver (i.e., a shaver, the blades of which are not driven by a motor relative to the shaving head) comprising:

a hollow handle,

a shaving head borne by the handle, and

an electric vibratory including a rigid casing which is fixed inside the handle, for transmitting vibrations to the shaving head through the handle.

In vibrating shavers of this type, it is necessary to achieve an intimate contact between the rigid casing of the vibratory and the handle, in order to efficiently transmit vibrations from the electric vibratory to the handle and then from the handle to the shaving head.

U.S. Pat. No. 5,299,354 discloses an example of such a known vibrating shaver, in which the intimate contact between the casing of the electric vibratory and the handle is obtained by gluing the casing in the handle, which makes the manufacturing process of the shaver more expensive.

### OBJECTS AND SUMMARY OF THE EMBODIMENTS OF THE PRESENT INVENTION

One objective of an embodiment of the present invention is to avoid this drawback.

To this end, according to the embodiments of the present invention, in a vibrating shaver of the type in question, the casing of the vibratory is tightly fitted in the handle, and at least an elastomeric layer is interposed between the casing and the handle.

Thanks to these dispositions, it is possible to obtain a tight fitting of the rigid casing of the electric vibratory inside the handle without requiring excessively precise tolerances of the rigid casing and/or of the handle.

Further, these dispositions also limit noises generated by the vibratory, by reliably and durably ensuring an intimate contact between the rigid casing of the electric vibratory and the handle. In particular, these dispositions avoid attrition phenomena of the bearing surfaces of the handle which bear the electric casing, which attrition phenomena would progressively create a clearance enabling the casing to noisily hit the bearing surfaces, especially when these bearing surfaces are made out of plastic material.

In various embodiments of the present invention, one may possibly have recourse in addition to one and/or other of the following arrangements:

the elastomeric layer has a thickness comprised between 0.2 and 1 mm;

the elastomeric layer has a thickness comprised between 0,2 and 0,6 mm where the elastomeric layer is compressed between the casing of the vibratory and the handle; the elastomeric layer comprises a silicon layer;

the elastomeric layer has a Shore hardness comprised between 70 Shore A and 90 Shore A;

the elastomeric layer includes an elastomeric sleeve surrounding the casing of the vibratory;

the handle extends between a proximal portion and a distal portion in a longitudinal direction (straight or curved), the handle including a body comprising first and second body portions which are fixed to one another and which face each other in a first transverse direction substantially perpendicular to the longitudinal direction, the first body portion including at least a first bearing surface and the second body portion including at least a second bearing surface, the casing of the vibratory being tightly fitted between the first and second bearing surfaces;

the handle comprises several similar first bearing surfaces and/or several similar second bearing surfaces;

the body is made out of thermoplastic material;

the first bearing surface has a substantially U shape, with a base surface and two substantially parallel side surfaces facing each other in a second transverse direction substantially perpendicular to the first transverse direction and substantially perpendicular to the longitudinal direction;

the casing of the vibratory is substantially circular in cross section and has two diametrically opposed portions clamped between the side surfaces of the first bearing surface, which facilitates the manufacturing process of the shaver;

the elastomeric layer is more compressed in the second transverse direction between the two side surfaces of the first bearing surface than in the first transverse direction between the second bearing surface and the base surface of the first bearing surface, which again facilitates the manufacturing process, since it is easier to obtain precise tolerances between the side surfaces, which belong to the same body portion, than between the second bearing surface and the base surface which belong to two different body portions;

the casing of the vibratory is axially fitted between two abutments belonging to the first body portion, parallel to the longitudinal direction;

the vibratory includes an electric motor comprising the casing, an output shaft adapted to be rotated by the motor and an eccentric mass borne by the shaft;

the handle extends longitudinally between a proximal portion and a distal portion bearing the shaving head, the electric vibratory being situated close to the distal portion;

the shaver further comprises a switch adapted to control the electric vibratory, the switch being mounted inside the handle between the vibratory and the proximal portion;

the switch includes a pusher and the handle includes a flexible wall in correspondence with the pusher, enabling a user to act on the pusher by deforming the flexible wall;

the handle includes a body made out of plastic material and having a hollow portion in correspondence with the switch, the hollow portion being covered by an elastomeric trim including the flexible wall;

the body includes a flexible tongue which is interposed between the flexible wall and the pusher of the switch;

the handle further includes a battery housing which is situated between the switch and the proximal portion, the battery housing including electrical contacts connected to the switch; the proximal portion of the handle includes a removable end cap which enables to open the battery housing in order to exchange batteries;

the handle extends between a proximal portion and a distal portion in a longitudinal direction, the handle exhibiting first and second transverse directions substantially perpendicular to the longitudinal direction and perpendicular to one another, and wherein the handle includes means for increasing a rigidity of the elastomeric layer in the second transverse direction compared to the first transverse direction;

the handle extends between a proximal portion and a distal portion in a longitudinal direction, the handle exhibiting first and second transverse directions substantially perpendicular to the longitudinal direction and perpendicular to one another, and wherein the handle includes means for increasing a compression of the elastomeric layer in the second transverse direction compared to the first transverse direction;

the handle extends between a proximal portion and a distal portion in a longitudinal direction, the handle exhibiting first and second transverse directions substantially perpendicular to the longitudinal direction and perpendicular to one another, and wherein the handle includes means for increasing a vibration amplitude of the shaver head in the first transverse direction compared to the second transverse direction;

the shaving head has a front face equipped with blades having blade edges, and wherein the second transverse direction is substantially parallel to the blade edges;

the side surfaces of the first bearing surface include substantially flat portions which extend substantially parallel to the first transverse direction.

### BRIEF DESCRIPTION OF THE DRAWINGS

Other features and advantages of the embodiments of the present invention appear from the following detailed description of two of its embodiments, given by way of non-limiting example, and with reference to the accompanying drawings.

In the drawings:

FIGS. 1a and 1b are respectively perspective views of a shaver according to a first embodiment of the invention, seen from above and from below,

FIG. 2 is an exploded perspective of the shaver of FIGS. 1a and 1b, seen from above,

FIG. 3 is an exploded perspective view of the shaver of FIGS. 1a and 1b, seen from below,

FIG. 4 is a longitudinal cross section of the shaver of FIG. 1,

FIGS. 5-7 are respectively transverse cross sections along lines V-V, VI-VI and VII-VII of FIG. 4,

FIGS. 8a and 8b are two perspective views, seen in two different directions, of the lock/release mechanism connecting the razor handle to the shaving head in the shaver of FIGS. 1a and 1b,

FIG. 9 is a rear view of the shaving head in the shaver of FIGS. 1a and 1b,

FIGS. 10 and 11 are cross sections of the lock/release mechanism of FIGS. 8a and 8b, respectively in the head locking position and in the head release position, and

FIGS. 12 and 13 are similar views to FIGS. 6 and 7, in a second embodiment of the invention.

In the figures, the same references denote identical or similar elements.

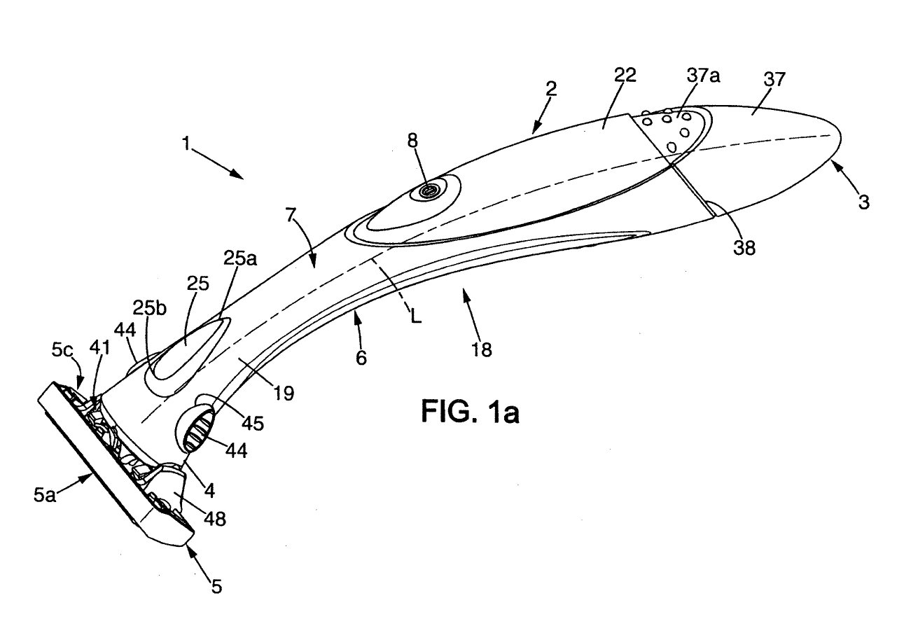

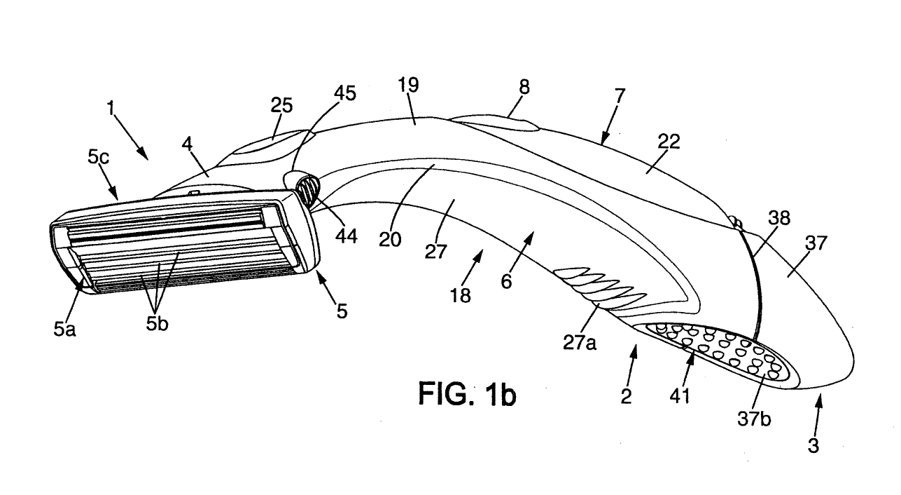

FIGS. 1a and 1b show a wet shaver 1, i.e. a shaver the blades of which are not driven by a motor relative to the shaving head.

The shaver 1 includes a hollow handle 2 extending in a longitudinal direction L between a proximal portion 3 and a distal portion 4 bearing a shaving head 5. The shaving head 5 includes a front face 5a equipped with one or several blades 5b and a rear face 5c which is connected to the handle 2.

The longitudinal direction L may be curved or include one or several straight portions. In the present case, the longitudinal direction L is curved, with a concavity which is constantly directed toward the underside 6 of the handle (i.e. the side of the handle which faces substantially the same direction as the front face 5a of the shaving head).

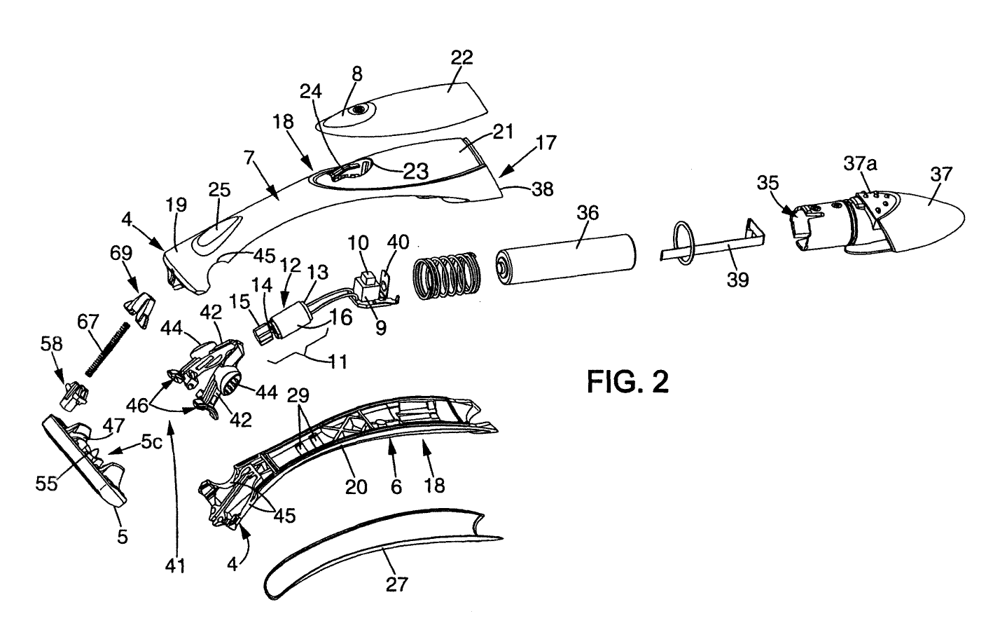

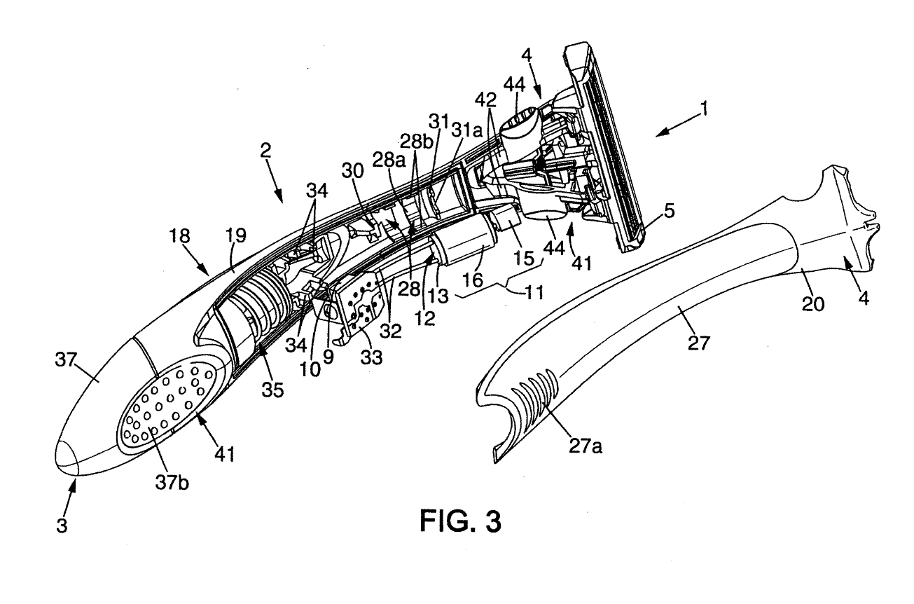

The shaver may further include, for instance on the top side 7 of the handle (i.e. the side of the handle which faces opposite the front face 5a of the shaving head), a flexible wall 8 which enables to actuate a switch 9 (see FIGS. 2 and 3) mounted inside the hollow handle 2, for instance by pressing on a pusher 10 of the switch when depressing the flexible wall 8.

The switch 9 controls an electric vibratory 11 (see FIGS. 2-4) which is able to generate vibrations and transmits them to the handle 2. The electric vibratory may include for instance:

an electric motor 12 having a rigid outer casing 13,

an output shaft 14 rotated by the electric motor 12,

and an eccentric mass 15 which is mounted on the output shaft 14.

As it will be explained in further details hereafter, the rigid outer casing 13 of the electric motor 12 is tightly fitted in the handle 2, in the vicinity of the distal portion 4, with interposition of an elastomeric layer 16 between the casing and the handle.

The casing 13 may be circular in cross section, and may in particular have substantially the shape of a circular cylinder and the elastomeric layer 16 may surround the casing 13 of the vibratory. The elastomeric layer may be in the form of an elastomeric sleeve surrounding the casing of the vibratory or more generally may include such elastomeric sleeve.

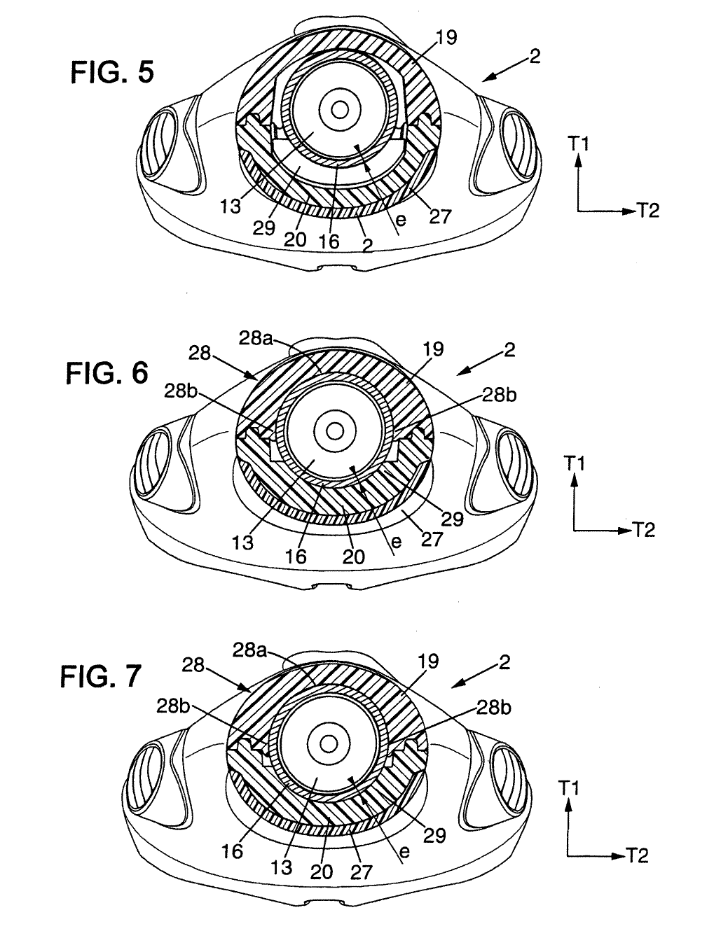

As shown in FIGS. 5-7, the thickness “e” of the elastomeric layer may be comprised, for instance, between 0.2 and 1 mm. More particularly, where the elastomeric layer 16 is compressed between the casing 13 and the handle 2, the thickness “e” may be comprised between 0.2 and 0.6 mm, and for instance be around 0.4 mm, whereas in the portions where the elastomeric layer is not compressed between the casing and the vibratory, the thickness “e” of such layer may be comprised for instance between 0.4 and 1 mm.

The elastomeric layer 16 may for instance be a silicone layer or more generally may comprise such silicone layer, and the elastomeric layer may have a Shore hardness comprised for instance between 70 Shore A and 90 Shore A. The Shore hardness may be for instance around 75 Shore A. The layer 16 could also be made out of or comprise neoprene.

In the example considered here, as shown for instance in FIGS. 2 and 3, the handle may include a substantially rigid hollow body 17 (as opposed to softer elastomeric parts of the handle), made out for instance of plastic material, e.g. of molded thermoplastic.

The body 17 may form the distal portion 4 of the handle and the medial portion 18 of the handle, and the body 17 may comprise:

a first body portion 19 forming for instance part of the top side 7 of the handle,

and a second body portion 20 which may form for instance part of the underside 6 of the handle.

The first body portion 19 may include a recessed portion 21 on which is fixed an elastomeric trim 22 which includes the flexible wall 8 in correspondence with a hollow portion 23 which is hollowed out in the recessed portion 21 in correspondence with the pusher 10 of the switch 9.

The first body portion 19 may also include a flexible tongue 24 protruding substantially parallel to the longitudinal direction L in the hollow portion 23 and interposed between the flexible wall 8 and the pusher 10. The flexible tongue 24 is elastically flexed and presses on the pusher 10 when a user depresses the flexible wall 8, and the flexible tongue 24 thereafter elastically returns the flexible wall 8 toward its normal position. In this normal position, the flexible wall 8 may for instance slightly protrude upwardly from the elastomeric trim 22.

Besides, the first body portion 19 may also include, in the example shown in the drawings, an index pad 25 on which the index finger of the user of the shaver may rest (see FIG. 2). This index pad 25 may for instance extend with an increasing width, between a rear tip 25a and a front end which is wider than the rear tip and which is closer to the shaving head 5 (see FIG. 1a). The index pad 25 may be made for instance out of elastomer.

Besides, as shown for instance on FIGS. 2 and 3, the second body portion 20 may also include an outer recess portion 26 in which is fixed a further elastomeric trim 27. The trim 27 may include for instance transverse ribs 27a at the end of the trim which is opposite the distal portion 4 of the handle.

The elastomeric trims 22, 27 may be fixed to the corresponding body portions 19, 20 by any suitable means, for instance by co-injection.

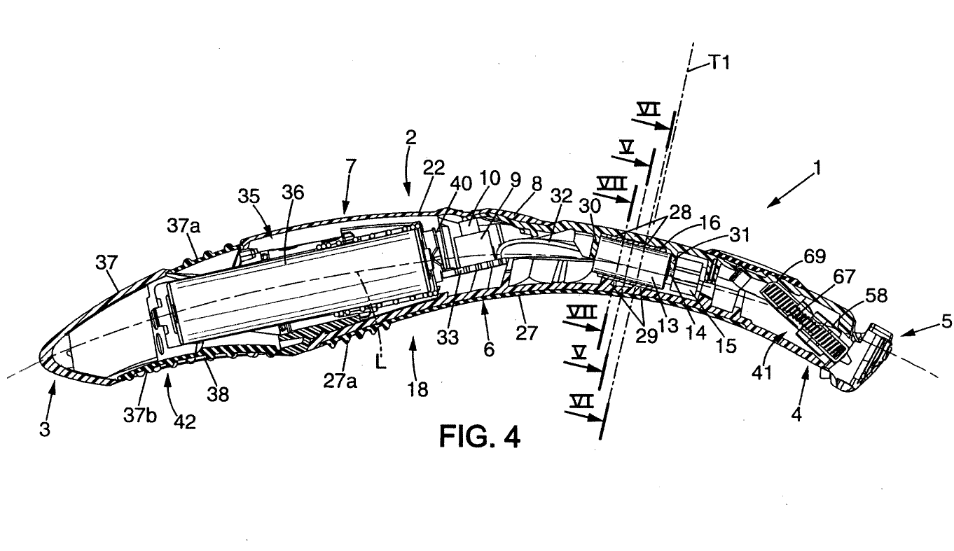

The first and second body portions 19, 20 are facing each other in a first transverse direction T1 (FIG. 4) which is substantially perpendicular to the longitudinal direction L at the level of the motor 12 and which is comprised in a medial plane of symmetry of the shaver 1. More precisely, the first transverse direction, as shown in FIG. 4, is perpendicular to the output shaft 14 of the motor and substantially perpendicular to the cutting edges of the blades 5b.

The first and second body portions 19, 20 may be fixed together by fitting and by ultrasonic welding. However, the first and second body portions could be fixed together by any other means, such as snap fitting, gluing, etc.

The casing 13 of the motor may be for instance tightly fitted between:

at least one, for instance two concave bearing surfaces 28 belonging to the first body portion 19 and facing toward the second body portion 20 parallel to the first transverse direction T1 (see FIGS. 3 and 6),

and at least one, for instance two second concave bearing surfaces 29 belonging to the second body portion 20 and facing toward the first body portion 19 in the first transverse direction T1 (FIGS. 2 and 7).

These first and second bearing surfaces, which may be either in mutual correspondence on both sides of the motor 12 or axially offset along the longitudinal direction L of the motor 12, are more clearly visible on FIGS. 6 and 7.

As shown on FIG. 6, the or each first bearing surface 28 may have a substantially U shape, with a base surface 28a and two substantially parallel side surfaces 28b facing each other in a second transverse direction T2 substantially perpendicular to the first transverse direction T1 and to the longitudinal direction L (T2 is therefore substantially parallel to the cutting edges of the blades 5b). These side surfaces 28b may be disposed to be clamped onto substantially diametrically opposed portions of the casing 13, with interposition of the elastomeric layer 16. This feature enables an easier manufacturing process, since the motor 12 may thus be retained in the first bearing surface 28 after being mounted therein, before mounting of the second body portion 20 onto the first body portion 19.

Besides, in the embodiment shown in the drawings, the elastomeric layer 16 may be more compressed in the second transverse direction T2 between the two side surfaces 28b of the first bearing surface 28 (FIG. 6), than in the first transverse direction T1 between the second bearing surface 29 and the base surface 28a of the first bearing surface.

This feature may also facilitate the manufacturing process, particularly since the tolerances of mutual positioning between the second bearing surface 29 and the base surface 28a parallel to the first transverse direction T1 may be larger than the tolerances between the side surfaces 28b parallel to the second transverse direction T2. As shown in FIGS. 3 and 4, the casing 13 of the motor is also axially fitted between two abutments, parallel to the longitudinal direction L, to with a rear abutment 30 belonging for instance to the first body portion and a front abutment 31 which may also belong to the first body portion.

The front abutment 31 which may include a cut out 31a for the output shaft 14 of the motor, the front abutment being axially interposed between the casing 13 and the eccentric mass 15, preferably without contact between front abutment 31 and the eccentric mass 15.

As shown in FIG. 3, the switch 9 is mounted between the vibratory 11 and the proximal portion 3 of the handle, close to the vibratory 3, and is connected to the motor 12 by electric wires 32. The switch 9 may be fixed to a base plate 33 such as an electronic circuit board, which is itself fitted in support members 34 belonging for instance to the first body portion 19.

Besides, the handle further includes a battery housing 35 (see FIGS. 3 and 4) which is situated between the switch 9 and the proximal portion 3. This battery housing is adapted to receive a battery 36 extending longitudinally substantially parallel to the longitudinal direction L of the handle. This battery may be inserted in and removed from the battery housing 35 parallel to the longitudinal direction L, after removing an end cap 37 which forms the proximal portion 3 of the handle and which is axially fitted at the rear open end 38 of the body 17, the rear end being formed for instance by a portion of circular cross section of the first body portion 19, opposite to the shaving head 5.

As shown in FIGS. 2 and 4, the battery housing may further include two electrical contacts 39, 40 for connecting the battery to the switch. The electrical contact 39 may be in the form of a metallic strip which is fitted inside the end cap 37.

Besides, the end cap 37 may include for instance an upper finger rest portion 37a with protruding dots on the top surface of the handle, and a lower flattened portion 41 also with protruding dots. Both upper finger rest portion 37a and lower flattened portion 41 may be formed for instance out of elastomer or include an elastomeric trim.

As discussed previously, the distal portion 4 of the razor handle bears the shaving head 5. As shown in FIGS. 1a and 1b, the shaving head 5 includes a front face 5a having one or several blades 5b exposed thereon, and a rear face 5c which is connected to the handle 2.

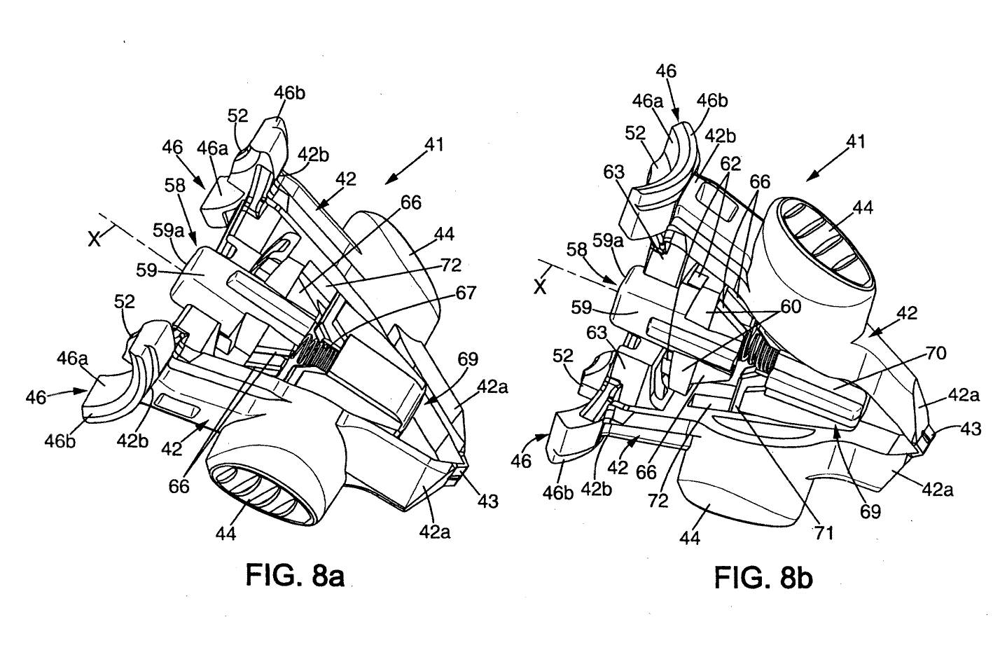

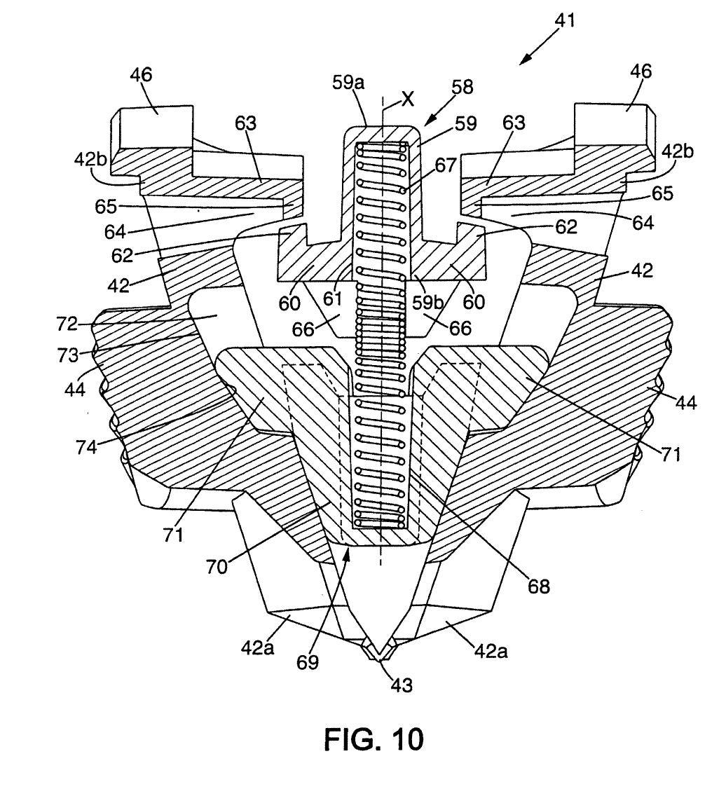

In the example shown in the drawings, the rear face 5c of the shaving head is connected to the handle 2 by a lock/release mechanism 41 which is shown in greater details in FIGS. 8a, 8b and 10 and which enables to selectively:

either connect the shaving head 5 to the handle,

or release the shaving head in order to exchange shaving heads.

It should be noted that:

the vibrating mechanism described previously could be used with another type of connection between the shaving head and the handle,

and that the lock/release mechanism 41, which will now be described in greater details, could be used without any vibrating mechanism, or with a different vibrating mechanism.

As shown in greater details in FIGS. 2, 8a, 8b and 10, the lock/release mechanism 41 includes two arms 42 which can be made for instance out of molded plastic material. The two arms 42 may each extend from a first end 42a situated inside the handle body 17 toward a second end 42b which may protrude toward the outside at the distal portion 4 of the handle 2. The two arms may be disposed in a V shape, diverging from a medial axis X from their first end 42a toward their second end 42b. The medial axis X is substantially parallel to the curved longitudinal axis L of the handle.

The first ends 42a of the two arms 42 may be connected together by a hinge 43, formed for instance as a thin bridge of plastic material connecting the two arms 42 to each other when the arms are molded as a single piece. The hinge 43 may have a negligible resilient action, or no resilient action, on the two arms 42. The two arms 42 further include respectively two push buttons 44 which may be formed integrally therewith and which may protrude laterally out of the handle body 17, for instance through two holes 45 formed in the handle body (see FIGS. 1a, 1b and 2). The pushbuttons 44 may thus be surrounded by the handle body in all directions around the holes 45.

Returning to FIGS. 2, 8a, 8b and 10, the second ends 42b of the arms 42 may include respectively two bearings, in particular two shell bearings 46 which are exposed toward the outside. Each shell bearing 46 may for instance include a cylindrical concave front face 46a and a lateral edge 46b which protrudes outwardly and which has also a cylindrical shape. The two front faces 46a and the two lateral edges 46b have the same cylindrical axis, corresponding to the axis of rotation of the shaving head 5.

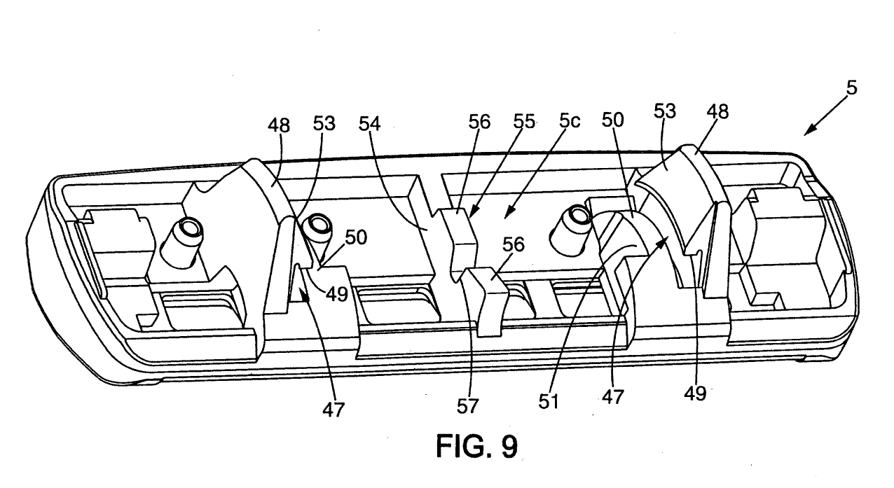

As shown in FIG. 9, the rear face 5c of the shaving head may include two inwardly facing arcuate slots 47 shaped in correspondence with the lateral edges 46b of the shell bearings and adapted to receive the lateral edges for pivotally mounting the shaving head 5 onto the handle 2. These arcuate slots 47 may be formed respectively in two protruding ribs 48 and may be limited:

toward the handle, by a first arcuate concave surface 49 facing toward the shaving head 5,

and away from the handle, by a larger second arcuate convex surface 50 facing toward the handle 2.

The front faces 46a of the shell bearings 46 bear respectively on the arcuate convex surfaces 50. The arcuate convex surfaces 50 may include respectively two notches 51 for receiving corresponding protrusions 52 of the shell bearings 46 (see FIGS. 8a and 8b), so as to limit the angular range of rotation of the shaving head 5.

Besides, as shown in FIG. 9, the ribs 48 may include two inclined surfaces 53 facing each other and extending slantwise toward each other from the top of the ribs 48 toward the arcuate slots 47, so as to facilitate the insertion of the shell bearings 46 in the arcuate slots 47.

The rear face 5c of the shaving head 5 may further include a central rib 54 having an edge forming a top cam surface 55 facing away from the shaving head 5 toward the handle 2. The cam surface 55 may have a generally V shape, and may for instance include two substantially flat surfaces 56 which are slightly inclined relative to one another and which may be for instance separated from one another by a notch 57 hollowed out in the rib 54 in order (e.g. to adapt the shaving head 5 on a other type of handle having a flexible tongue which is inserted into the notch 57).

Returning to FIGS. 2, 8a, 8b and 10, the lock/release mechanism 41 includes a plunger 58 which is movably mounted, substantially along the medial axis X between the two arms 42. This plunger 58 has a central body 59 and two lateral wings 60 extending opposite to one another toward the two arms 42. The central body 59 extends longitudinally parallel to the medial axis X, between a first, substantially flat free end 59a which bears against the cam surface 55 of the shaving head, and a second end 59b facing away from the shaving head 5. A recess 61 may be hollowed out in the central body 59, the recess forming a blind hole which opens at the second end 59b of the central body 59, in the direction of the handle 2.

Each lateral wing 60 may include a detent 62 protruding parallel to the medial axis X toward the shaving head 5, the detent facing an inwardly extending protrusion 63 belonging to the corresponding arm 42. The protrusion 63 has an opening 64 which is limited inwardly by a rim 65 belonging to the protrusion. Besides, the lateral wings 60 of the plunger 58 may each have respectively two ribs 66 which extend in a medial plane of the arms 42, opposite to the central body 59.

The plunger 58 is elastically biased toward the cam surface 55 of the shaving head so as to cooperate therewith by camming action to bias the shaving head in rotation toward a rest position. In the example shown in the drawings, the plunger 58 is elastically biased by a spring 67, for instance a helicoidal spring, which has a first spring end fitted into the recess 61. The spring 67 also has a second spring end fitted into a recess 68, for instance in the form of a blind hole, hollowed out in an arm pusher 69.

The arm pusher is disposed between the arms 42 in line with the plunger 58 along the medial axis X. The arm pusher 69 is disposed between the plunger 58 and the hinge 43 along the medial axis X. The recess 68 opens parallel to the medial axis X toward the plunger 58.

Besides, in the example shown in the drawings, the spring coils of the helicoidal spring 67 may be in mutual contact in a central portion of the spring 67, between the recesses 61, 68, and may be separate from each other between this central portion of the spring, except for the last spring coils at both ends of the spring.

The arm pusher is slidably mounted between the arms 42, substantially parallel to the medial axis X and is elastically biased by the spring 67 toward the handle, i.e. away from the shaving head 5. The arm pusher 69 cooperates by camming action with the two arms 42 for biasing the arms outwardly away from each other, toward a head locking position shown in FIGS. 8a, 8b and 10, where lateral edges 46b of the shell bearings 46 penetrate in the corresponding arcuate slots 47 of the shaving head.

The arm pusher 69 may have a central body 70 in which the recess 68 is hollowed out, and two lateral extensions 71 extending opposite to one another toward the two arms 42 and cooperating by camming action respectively with the two arms for biasing the arms toward the head locking position.

More particularly, the lateral extensions 71 may penetrate in two slots 72 formed respectively in the two arms and facing each other. The two lateral extensions 71 of the arm pusher may have lateral edges 74 which cooperate by camming action with the respective bottoms 73 of the slots. The lateral edges may be diverging from the medial axis X in a direction away from the handle 2, whereas the bottoms 73 may also diverge from the medial axis in the direction away from the handle.

Thanks to these dispositions, the same spring 67 is used to bias the plunger 58 elastically toward the cam surface 55 of the shaving head and to bias the arm pusher 69 away from the shaving head, thus biasing both the shaving head in rotation toward the rest position and the arms 42 toward the head lock position.

It should be noted that, in the position of FIGS. 8a, 8b, and 10, the plunger 58 is maintained between the two arms 42 both by cooperation with the spring 67, by abutment against the cam surface 55 of the shaving head, and eventually by abutment against the protrusions 63 of the arms 42.

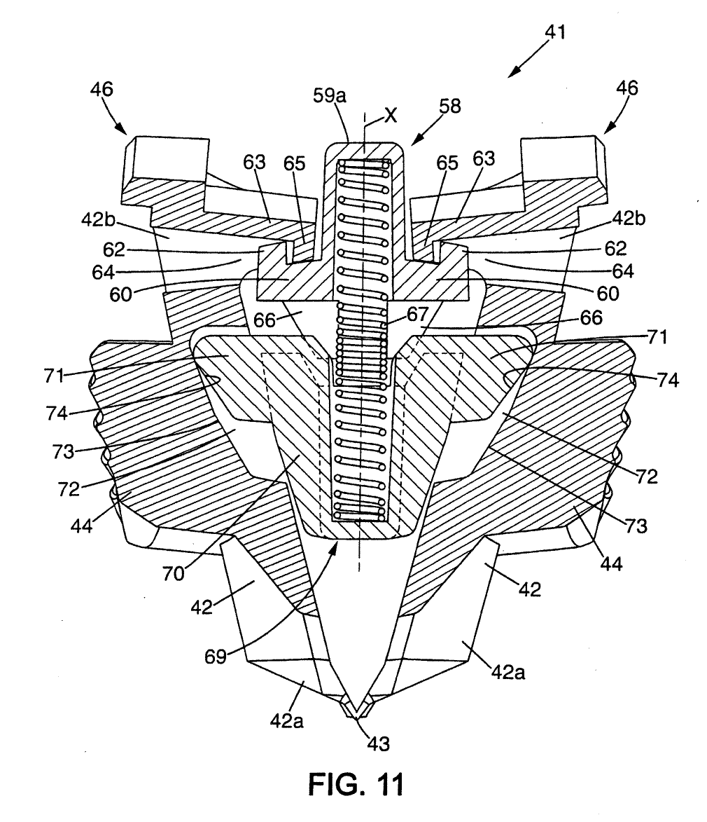

When a shaving head 5 is mounted on the handle 2, the lock/release mechanism 41 is normally in the head lock position. Starting from this position, when a user wishes to exchange shaving heads, he first pushes on both pushbuttons 44, which rotates the arm 42 toward each other against the camming action of the arm pusher 69. During this movement, the arm pusher 69 slides along the medial axis X toward the plunger 58, and the arm pusher partially penetrates between the ribs 66 of the plunger. When the arms 42 have sufficiently rotated toward each other to reach the head release position shown in FIG. 11, the head is released by the shell bearings 46 and is simultaneously ejected by the plunger 58.

The plunger 58 then moves forward to an outwardly protruding position, so that the detents 62 of the plunger penetrate in the recesses 64 of the extensions 63 of the arms. In this position, as shown in FIG. 11, the arms 42 are maintained in the head release position by abutment of the rims 65 against the detents 62, thus cooperating by hooking action. Afterwards, when a new shaving head 5 is fixed to the handle 2, the shell bearings 46 are inserted between the arcuate slots 47 of the new shaving head 5 and the cam surface 55 of the new shaving head pushes the plunger 58 backward toward the handle. The arms 42 are then released and rotate away from each other under the action of the arm pusher 69, so that the shell bearings 46 insert themselves in the arcuate slots 47 of the new shaving head, and the lock/release mechanism 41 is again in the position shown in FIGS. 8a, 8b and 10.

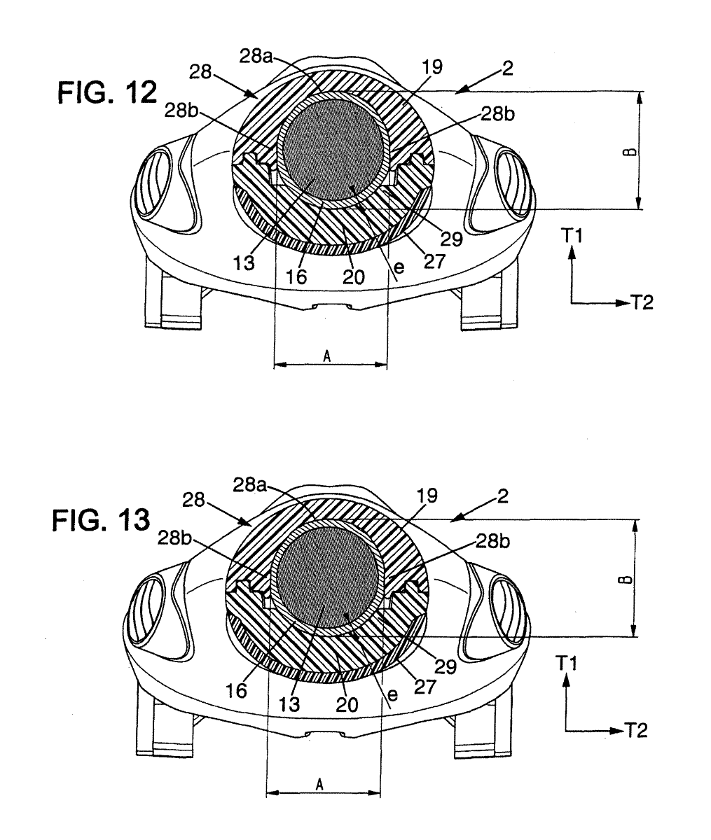

In the second embodiment of the present invention, the shaver is identical or similar to the shaver described with regard to FIGS. 1-11 except that, as shown in FIGS. 12 and 13, the two side surfaces 28b of each first bearing surface 28 the side surfaces of the first bearing surface include substantially flat end portions which extend substantially parallel to the first transverse direction T1. This feature enables to compress the elastomeric layer 16 in the second transverse direction T2 between the two side surfaces 28b, even more than in the first embodiment of the invention.

Therefore, in the second embodiment of the present invention, while the elastomeric layer 16 has initially a circular form before mounting in the shaver, this layer becomes flattened in the transverse direction T2 after mounting and then exhibits a dimension A in the transverse direction T2, which is smaller than a dimension B of the elastomeric layer 16 in the first transverse direction T1 (the elastomeric layer 16 is less compressed between the second bearing surface 29 and the base surface 28a of the first bearing surface than between the side surfaces 28b).

Having an elastomeric layer which is more compressed (and hence more rigid) in transverse direction T2 than in transverse direction T1 enables to obtain vibrations of the shaving head which are larger in transverse direction T1 than in transverse direction T2. In other words, the amplitude of the vibrations will be larger in a direction substantially perpendicular to the skin of the user than parallel to the skin, which maximizes the efficiency of the vibrations.

By having different compressions (and hence different rigidities) of the elastomeric layer 16 in different directions, it is thus possible to polarize the vibrations more in one direction than in the other: the oscillatory movement of the shaving head then becomes an ellipse with a larger axis in the direction of the least compression (and hence of the least rigidity) of the elastomeric layer 16 and a smaller axis in the direction of the largest compression (and hence of the largest rigidity) of the elastomeric layer 16.

It should be noted that it would be possible to vary the amplitude of the vibrations of the shaver head in a particular direction by varying the compression (and hence rigidity) of the elastomeric sleeve in this direction. For instance, by using a clamping device controlled by a screw, it would be possible to enable to enable a user to modify the amplitude of the vibrations in a direction.

We claim:

1.-26. (canceled)

27. A vibrating wet shaver comprising:
a hollow handle;
a shaving head borne by the handle; and
an electric vibratory including a rigid casing which is fixed inside the handle, for transmitting vibrations to the shaving head through the handle,
wherein the casing of the vibratory is tightly fitted in the handle, and at least an elastomeric layer is interposed between the casing and the handle.

28. The vibrating wet shaver according to claim 27, wherein the elastomeric layer has a thickness between about 0.2 and about 1 mm.

29. The vibrating wet shaver according to claim 28, wherein the elastomeric layer has a thickness between about 0.2 and about 0.6 mm when the elastomeric layer is compressed between the casing of the vibratory and the handle.

30. The vibrating wet shaver according to claim 29, wherein the elastomeric layer comprises a silicon layer.

31. The vibrating wet shaver according to claim 30, wherein the elastomeric layer has a Shore hardness between about 70 Shore A and about 90 Shore A.

32. The vibrating wet shaver according to claim 31, wherein the elastomeric layer includes an elastomeric sleeve surrounding the casing of the vibratory.

33. The vibrating wet shaver according to claim 27, wherein the handle extends between a proximal portion and a distal portion in a longitudinal direction, the handle including a body comprising first and second body portions which are fixed to one another and which face each other in a first transverse direction substantially perpendicular to the longitudinal direction, the first body portion including at least a first concave bearing surface and the second body portion including at least a second concave bearing surface, the casing of the vibratory being tightly fitted between the first and second bearing surfaces.

34. The vibrating wet shaver according to claim 33, wherein the handle comprises several similar first bearing surfaces and several similar second bearing surfaces.

35. The vibrating wet shaver according to claim 33, wherein the body is made out of thermoplastic material.

36. The vibrating wet shaver according to claim 33, wherein the first bearing surface has a substantially U shape, with a base surface and two substantially parallel side surfaces facing each other in a second transverse direction substantially perpendicular to the first transverse direction and substantially perpendicular to the longitudinal direction.

37. The vibrating wet shaver according to claim 33, wherein the casing of the vibratory is substantially circular in cross section and has two diametrically opposed portions clamped between the side surfaces of the first bearing surface.

38. The vibrating wet shaver according to claim 29, wherein the elastomeric layer is more compressed in the second transverse direction between the side surfaces of the first bearing surface than in the first transverse direction between the second bearing surface and the base surface of the first bearing surface.

39. The vibrating wet shaver according to claim 33, wherein the casing of the vibratory is axially fitted between two abutments belonging to the first body portion, parallel to the longitudinal direction.

40. The vibrating wet shaver according to claim 27, wherein the vibratory includes an electric motor comprising a casing, an output shaft adapted to be rotated by the motor and an eccentric mass borne by a shaft.

41. The vibrating wet shaver according to claim 27, wherein the handle extends longitudinally between a proximal portion and a distal portion bearing the shaving head, the electric vibratory being situated close to the distal portion.

42. The vibrating wet shaver according to claim 27, wherein the shaver further comprises a switch adapted to control the electric vibratory, the switch being mounted inside the handle between the vibratory and a proximal portion of the handle.

43. The vibrating wet shaver according claim 42, wherein the switch includes a pusher and the handle includes a flexible wall in correspondence with the pusher, enabling a user to act on the pusher by deforming the flexible wall.

44. The vibrating wet shaver according to claim 43, wherein the handle includes a body having a hollow portion in correspondence with the switch, the hollow portion being covered by an elastomeric trim including the flexible wall.

45. The vibrating wet shaver according to claim 44, wherein the body includes a flexible tongue which is interposed between the flexible wall and the pusher of the switch.

46. The vibrating wet shaver according to claim 44, wherein the handle further includes a battery housing which is situated between the switch and the proximal portion, the battery housing including electrical contacts connected to the switch.

47. The vibrating wet shaver according to claim 46, wherein the proximal portion of the handle includes a removable end cap which enables to open the battery housing in order to exchange batteries.

48. The vibrating wet shaver according to claim 27, wherein the handle extends between a proximal portion and a distal portion in a longitudinal direction, the handle exhibiting first and second transverse directions substantially perpendicular to the longitudinal direction and perpendicular to one another, and wherein the handle includes means for increasing a rigidity of the elastomeric layer in the second transverse direction compared to the first transverse direction.

49. The vibrating wet shaver according to claim 27, wherein the handle extends between a proximal portion and a distal portion in a longitudinal direction, the handle exhibiting first and second transverse directions substantially perpendicular to the longitudinal direction and perpendicular to one another, and wherein the handle includes means for increasing a compression of the elastomeric layer in the second transverse direction compared to the first transverse direction.

50. The vibrating wet shaver according to claim 27, wherein the handle extends between a proximal portion and a distal portion in a longitudinal direction, the handle exhibiting first and second transverse directions substantially perpendicular to the longitudinal direction and perpendicular to one another, and wherein the handle includes means for increasing a vibration amplitude of the shaver head in the first transverse direction compared to the second transverse direction.

51. The vibrating wet shaver according to claim 50, wherein the shaving head has a front face equipped with blades having blade edges, and wherein the second transverse direction is substantially parallel to the blade edges.

52. The vibrating wet shaver according to claim 50, wherein the side surfaces of the first bearing surface include substantially flat portions which extend substantially parallel to the first transverse direction.

53. A vibrating wet shaver comprising:
a hollow handle;
a shaving head borne by the handle; and
an electric vibratory including a rigid casing which is fixed inside the handle, for transmitting vibrations to the shaving head through the handle,
wherein the casing of the vibratory is tightly fitted in the handle, and at least an elastomeric layer is interposed between the casing and the handle, and
wherein the vibratory includes an electric motor that includes a casing, an output shaft adapted to be rotated by the motor and an eccentric mass borne by a shaft.

54. A vibrating wet shaver comprising:
a hollow handle;
a shaving head borne by the handle; and
an electric vibratory including a rigid casing which is fixed inside the handle, for transmitting vibrations to the shaving head through the handle,
wherein the casing of the vibratory is tightly fitted in the handle, and at least an elastomeric layer is interposed between the casing and the handle,
wherein the handle extends between a proximal portion and a distal portion in a longitudinal direction, the handle exhibiting first and second transverse directions substantially perpendicular to the longitudinal direction and perpendicular to one another,
wherein the handle includes means for increasing a vibration amplitude of the shaver head in the first transverse direction compared to the second transverse direction, and
wherein the shaving head has a front face equipped with blades having blade edges, and wherein the second transverse direction is substantially parallel to the blade edges.
